(19) United States
(12) Patent Application Publication
(10) Pub. No.: US 2003/0201227 A1
(43) Pub. Date: Oct. 30, 2003

(54) Remediation of odorous media

(76) Inventor: Felix Anthony Perriello, Norwood, MA (US)

Correspondence Address: Alan G. Towner, Pietragallo, Bosick & Gordon, One Oxford Centre, 38th Floor, 301 Grant Street, Pittsburgh, PA, 15219, US

(21) Appl. No.: 10/400,963

(22) Filed: Mar. 27, 2003

Related U.S. Application Data
(63) Continuation-in-part of application No. 10/308,607, filed on Dec. 2, 2002.
(63) Continuation-in-part of application No. 09/924,791, filed on Aug. 8, 2001.
(63) Continuation-in-part of application No. 09/275,320, filed on Mar. 24, 1999, now Pat. No. 6,245,235.
(63) Continuation-in-part of application No. 08/767,750, filed on Dec. 17, 1996, now Pat. No. 5,888,396.
(63) Continuation-in-part of application No. 10/324,663, filed on Dec. 20, 2002.
(63) Continuation-in-part of application No. 10/308,607, filed on Dec. 2, 2002.
(63) Continuation-in-part of application No. 09/924,791, filed on Aug. 8, 2001.
(60) Provisional application No. 60/368,219, filed on Mar. 28, 2002.
(60) Provisional application No. 60/291,165, filed on May 15, 2001.
(60) Provisional application No. 60/234,482, filed on Sep. 22, 2000.
(60) Provisional application No. 60/344,947, filed on Dec. 21, 2001.
(60) Provisional application No. 60/291,165, filed on May 15, 2001.

(51) Int. Cl. C02F 3/00

(52) U.S. Cl. 210/610; 210/611

(57) ABSTRACT

A method and apparatus are disclosed for remediating odorous media using an alkane substrate. The alkane substrate, such as butane, is introduced to the odorous medium in order to reduce or eliminate odors. The alkanes may remediate water, wastewater, soil, gas, solid waste, fish waste, algae and algal material.

### CROSS REFERENCE TO RELATED APPLICATIONS

This application claims the benefit of U.S. Provisional Patent Application Serial No. 60/368,219 filed Mar. 28, 2002.

This application is a continuation-in-part of U.S. patent application Ser. No. 10/308,607 filed Dec. 2, 2002, which is a continuation-in-part of U.S. patent application Ser. No. 09/924,791 filed Aug. 8, 2001, which claims the benefit of U.S. Provisional Patent Application Serial No. 60/291,165 filed May 15, 2001. The Ser. No. 10/308,607 application is also a continuation-in-part of U.S. application Ser. No. 09/729,039 filed Dec. 4, 2000, now U.S. Pat. No. 6,488,850 issued Dec. 3, 2002, which is a continuation-in-part of U.S. application Ser. No. 09/275,320 filed Mar. 24, 1999, now U.S. Pat. No. 6,245,235 issued Jun. 12, 2001, which is a continuation-in-part of U.S. application Ser. No. 08/767,750 filed Dec. 17, 1996, now U.S. Pat. No. 5,888,396 issued Mar. 30, 1999. The Ser. No. 09/729,039 application also claims the benefit of U.S. Provisional Application Serial No. 60/234,482 filed Sep. 22, 2000.

This application is also a continuation-in-part of U.S. patent application Ser. No. 10/324,663 filed Dec. 20, 2002, which claims the benefit of U.S. Provisional Application Serial No. 60/344,947 filed Dec. 21, 2001. The Ser. No. 10/324,663 application is a continuation-in-part of U.S. patent application Ser. No. 10/308,607 filed Dec. 2, 2002, which is a continuation-in-part of U.S. patent application Ser. No. 09/924,791 filed Aug. 8, 2001, which claims the benefit of U.S. Provisional Application Serial No. 60/291,165 filed May 15, 2001.

All of the foregoing applications and patents are incorporated herein by reference.

### FIELD OF THE INVENTION

The present invention relates to remediation of odorous media, and more particularly relates to remediation of odors from various sources using an alkane substrate such as butane and/or propane.

### BACKGROUND INFORMATION

Various industrial, municipal, commercial, agricultural, and household operations produce odors. Many odors are unpleasant and serve as a nuisance or health hazard to human and animal receptors. Odor is often a result of bacterial decomposition of organic matter. This decomposition produces unpleasant smelling gases as an interim by-product. Some types of chemical compounds that generate undesirable odors include mercaptans, ammonia, ammonia sulfides, hydrogen sulfides, disulfides, thiophenes, acids such as isovaleric acid, algal material, indole, skatole, amines, fatty acids and volatile organic compounds.

Most commercially available deodorizers on the market today simply mask odors. These masking agents contain perfumes that superimpose a pleasant odor upon an unpleasant one. Covering up odors that are offensive to humans and animals may control the odor for a short period of time, but the source of the odor is not eliminated.

In many industrial applications, caustic chemicals such as potassium permanganate are added to a wastestream in order to kill bacteria which produce odors. However, chemical addition is costly and can be dangerous. Other applications include biofilter or bioscrubbing technologies and fixed film digesters or trickling filters to remove noxious odors from process waste streams. Scrubbing media include carbon or zeolite materials.

The bioremediation of various pollutants such as chlorinated solvents and other types of pollutants using butane-utilizing bacteria is disclosed in U.S. Pat. Nos. 5,888,396, 6,051,130, 6,110,372, 6,156,203, 6,210,579, 6,245,235 and 6,488,850, which are incorporated herein by reference.

### SUMMARY OF THE INVENTION

The present invention provides a method of remediating an odorous medium using an alkane substrate, such as butane. The alkane substrate may reduce odors directly and/or may stimulate the growth of alkane-utilizing bacteria which may remove odors, e.g., by enzymatic interactions.

An aspect of the present invention is to provide a method of remediating an odorous medium by introducing an alkane substrate to the odorous medium.

Another aspect of the present invention is to provide an apparatus for introducing an alkane substrate to an odorous medium. The apparatus includes a source of alkane substrate and an injection system in communication with the source of alkane substrate and the odorous medium.

These and other aspects of the present invention will be more apparent from the following description.

### BRIEF DESCRIPTION OF THE DRAWINGS

FIG. 1 is a schematic illustration of a wastewater treatment process including butane enhanced odor control in accordance with an embodiment of the present invention.

FIG. 2 is a schematic illustration of a wastewater treatment process including butane enhanced odor control in accordance with another embodiment of the present invention.

FIG. 3 is a schematic illustration of a wastewater treatment process including butane enhanced odor control in accordance with a further embodiment of the present invention.

FIG. 4 is a partially schematic side view of a wastewater treatment vessel including a butane injection port for controlling odor in accordance with an embodiment of the present invention.

FIG. 5 is a partially schematic illustration of an ant habitat without a butane odor control system.

FIG. 6 is a partially schematic illustration of an ant habitat including a butane odor control system in accordance with an embodiment of the present invention.

### DETAILED DESCRIPTION

In accordance with the present invention, an alkane substrate is introduced to an odorous medium, thereby reducing, controlling or remediating the odor associated with the medium. As used herein, the term “introducing” means supplying the alkane substrate in a manner that effectuates odor reduction or control, including supplying the alkane substrate at or near the vicinity of the odorous medium, the odor-causing compounds, and/or the source of the odor-causing compounds. As used herein, the term “odorous medium” means any material that has an odor, produces an odor, or is related to the production of odor. Odor-causing compounds include mercaptans, ammonia, ammonia sulfides, hydrogen sulfides, disulfides, thiophenes, acids such as isovaleric acid, algal material, indole, skatole, amines, fatty acids, volatile organic compounds or related breakdown compounds, and the like. Examples of odorous media include water, wastewater, soil, gas, solid waste, fish waste, and the like. While not intending to be bound by any particular theory, the use of alkanes in accordance with the present invention may remediate odors by chemical reaction, counteraction, absorption, adsorption, neutralization, and/or dissolution. The alkanes may also stimulate the activity of alkane-utilizing bacteria, which reduce or remove odors, e.g., by enzymatic interactions.

Alkanes include butane, propane, methane and ethane. As used herein, the term “alkane substrate” includes liquids and gases in which an alkane is present in sufficient amounts to reduce odors or stimulate the growth of alkane-utilizing bacteria. Butane is preferably the most prevalent compound of the alkane substrate on a weight percent basis, and typically comprises at least about 10 weight percent of the alkane substrate. The other constituents of the alkane substrate may include any suitable compounds, including other alkanes such as methane, ethane, propane and natural gas. Inert gases may be added to the alkane substrate, e.g., as a pusher gas to facilitate delivery of the substrate to the treatment zone. In one embodiment, the alkane substrate comprises at least about 50 weight percent butane. For example, the alkane substrate comprises at least about 90 weight percent butane. In a particular embodiment, the alkane substrate comprises at least about 99 weight percent n-butane. The butane may contain straight (n-butane) and/or branched chain compounds (iso-butane).

In accordance with an embodiment of the present invention, the introduction of butane increases the number of butane oxidizers in nonaqueous environments such as soil and aqueous environment such as water or wastewater. Butane enrichment serves to increase the activity of butane-utilizing bacteria, which in turn may destroy odors by enzymatic interactions. The bacteria may produce enzymes that directly counteract and destroy the odor-creating agents and chemicals, e.g., ammonia, at or near the source. Odor-reducing bacteria may coexist within populations of odor-causing bacteria. Exposure to butane may result in the production of enzymes that degrade daughter or breakdown compounds responsible for odors.

In accordance with an embodiment of the present invention, butane may directly serve as a deodorizer. Butane is a large non-planar four carbon molecule. The butane molecular structure, reactive surface area and size may play a key role in causing butane to destroy and/or remove odors from soil, liquid and gaseous/air environments. In an aqueous or non-aqueous environment, butane in gaseous or liquid form may remove odors by chemically reacting, counteracting, absorbing, adsorbing, neutralizing and/or dissolving odors and toxic gases, which are unpleasant to humans and animals. For example, butane may act as a gaseous carbon scrubber for many odors. Butane may thus reduce, remove and/or destroy odors by various means such as direct absorption and/or by stimulating the growth of butane-utilizing bacteria at or near the odor source.

Although the use of butane in the alkane substrate is primarily described herein, it is to be understood that other alkanes, e.g., propane, methane, and ethane, may be used in addition to, or in place of, butane. For example, the alkanes may be provided in the form of natural gas. Alternatively, the alkane substrate may be at least partially replaced or substituted with a petroleum hydrocarbon substrate, e.g., comprising diesel fuels and fuel oils including petroleum hydrocarbons in the C₁ to C₂₀ range. The alkane or petroleum hydrocarbon substrate may be provided in any desired form such as a liquid or gas injected into the odorous medium or treatment apparatus, or within a capsule that dissolves in liquid or gas.

Oxygen may be introduced into the odorous medium or treatment apparatus to stimulate the activity of odor-reducing bacteria. As used herein, the term “oxygen-containing gas” means a gas that comprises oxygen, including pure oxygen as well as mixtures of oxygen with other gases. For example, the oxygen-containing gas may comprise air, pure oxygen, or oxygen blended with inert gases such as helium, argon, nitrogen, carbon monoxide or the like.

Typical applications or industries for this invention include solid waste, landfill, wastewater, septic systems, sanitary sewer systems, water distribution systems, poultry processing, fish processing, fish waste, meat processing and slaughterhouse industries, animal and produce farms including dry litter operations, dairy and milk-producing farms, farming, fertilizer, semi-conductor, railroad transportation, switching and terminal facilities, bus service facilities, trucking and warehousing, marine cargo handling, cargo transportation, packing and crating, scrap and waste material, fabric finishing plants, textile industries, cordage and twine, lumber and wood industries, paper and allied products, pulp mills, electroplating, petroleum and coal products, rubber and plastics industries, residential or family dwellings, restaurant and food processing facilities.

Butane as well as other alkanes may reduce noticeable odor for chemicals such as sulfides, hydrogen sulfide, carbonyl sulfide, mercaptans, methyl mercaptan, ethyl mercaptan, dimethyl sulfide, carbon disulfide, isopropyl mercaptan, tert-butyl mercaptan, n-propyl mercaptan, ethyl methyl sulfide, thiophene, isobutyl mercaptan, diethyl sulfide, n-butyl mercaptan, dimethyl disulfide, 3-methylthiophene, tetrahydrothiophene, 2,5-dimethylthiophene, diethyl disulfide, thiophenes, ammonia, acids such as isovaleric acid, algal material, indole, skatole, amines, fatty acids, and volatile organic compounds. These odor-generating compounds are particularly prevalent in the wastewater industry. However, the present invention also applies to a wide range of other odor-generating compounds, including algae and algal material or by-products. The introduction of butane into an algal population may result in the destruction or control of algal metabolites responsible for odors or malodors. Algal populations may include marine, estuarine, freshwater, terrestrial (including caves) and airborne algae.

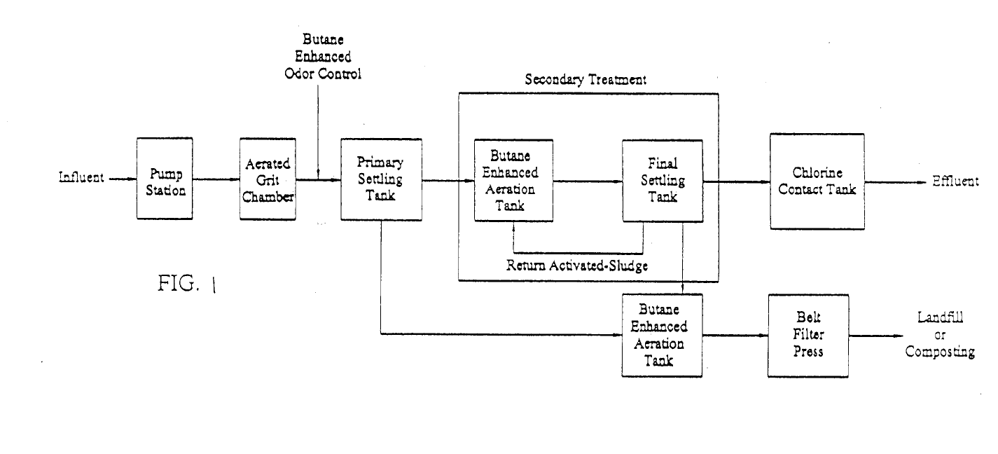

FIG. 1 is a schematic diagram illustrating odor reduction in a butane-enhanced wastewater treatment process in accordance with an embodiment of the present invention. In the embodiment shown in FIG. 1, butane-enhanced odor control is achieved by introducing a butane substrate into the wastewater prior to the primary settling tank. After the primary settling tank, the wastewater may flow to a butane-enhanced aeration tank, then to a belt filter press. In addition, wastewater from the primary settling tank may be fed to a butane-enhanced aeration tank for secondary treatment. In the secondary treatment stage, return activated sludge is fed to the butane-aeration tank and then to a final settling tank. After the final settling tank, the wastewater may be fed to a chlorine contact tank and/or another butane-enhanced aeration tank.

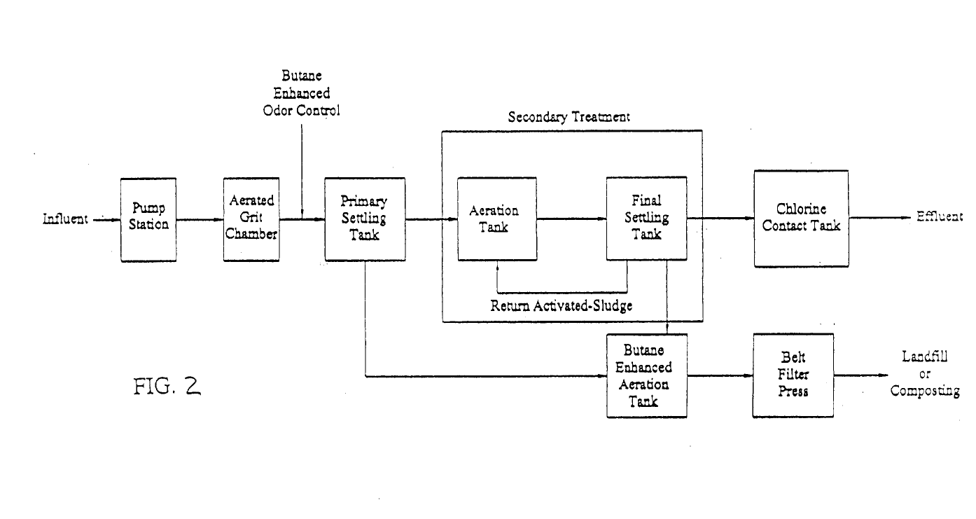

The embodiment shown in FIG. 2 is similar to the embodiment shown in FIG. 1, except the secondary treatment stage includes a standard aeration tank, rather than a butane-enhanced aeration tank.

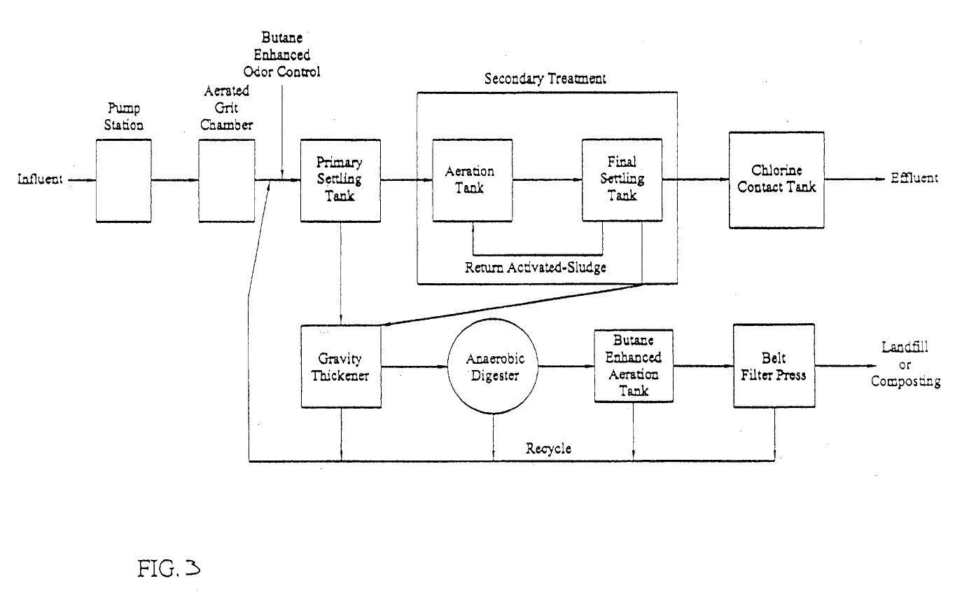

FIG. 3 is a schematic diagram illustrating odor reduction in a butane-enhanced wastewater treatment process in accordance with another embodiment of the present invention. In the embodiment shown in FIG. 3, wastewater undergoes butane-enhanced odor control before it is fed to a primary settling tank. A secondary treatment stage similar to that shown in FIG. 2 is used, except the final settling tank is connected to a gravity thickener. Wastewater exiting the gravity thickener is fed to an anaerobic digestor, followed by a butane-enhanced aeration tank. After treatment in the butane-enhanced aeration tank, the wastewater is fed to a belt filter press. Some of the material from the gravity thickener, anaerobic digestor, butane-enhanced aeration tank and belt filter press may be recycled to the primary settling tank.

The following examples are intended to illustrate various aspects of the present invention and are not intended to limit the disclosure or claims of the invention.

### EXAMPLE 1

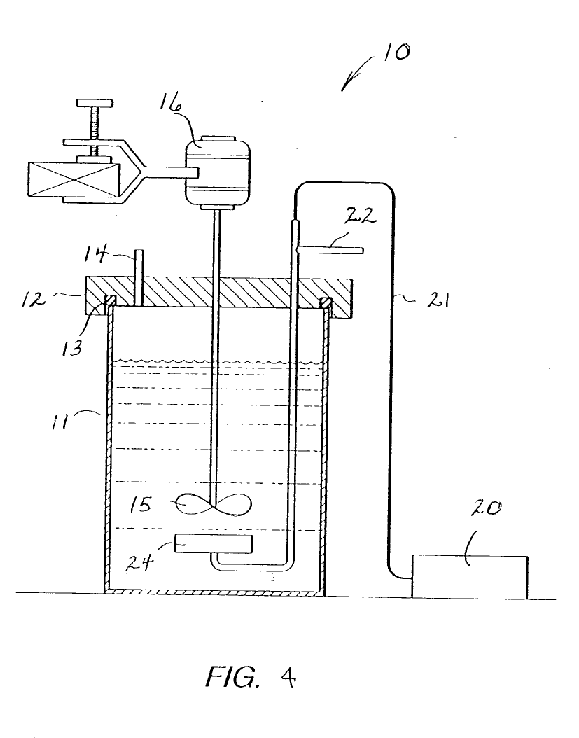

Return activated-sludge (RAS) was collected from a municipal wastewater treatment plant located in Massachusetts. The RAS was drawn from the return line of a settling tank (after treatment in an aeration tank) in an activated-sludge process municipal wastewater treatment plant. RAS consists of the mixture of old and new aerobic bacterial cells, which have settled out in the settling tank over a period of time. The activated-sludge was introduced into a bioreactor vessel comprising aeration diffusers, a constant speed electric mixer with propeller, an air-supply pump, and vent line, as illustrated in FIG. 4. The bioreactor 10 shown in FIG. 4 includes a containment vessel 11 with a screw down cover 12 sealed with a gasket 13. A vent line 14 extends through the cover 12. An impeller 15 mounted in the vessel 11 is rotated by a motor assembly 16. An air supply pump 20 is connected to an air feed line 21. A butane injection port 22 is connected to the air feed line 21. A diffuser 24 is connected at the end of the air feed line 21.

The reactor contained approximately five gallons of organic waste, which consisted of water with the addition of the return activated-sludge from the treatment plant, the return activated-sludge appeared to have the consistency of slurry prior to the addition of water. Prior to the butane injections, the solids were thoroughly mixed and a composite sample was drawn for analysis of total solids. The results are summarized in Table 1 below. The constant speed mixer and aeration system were operated continually (200 liters per hour) with brief stops every hour to conduct butane injections (500 ml of n-butane. The butane was injected into a syringe port connected to the air-supply line at hourly intervals as shown on Table 1 and in FIG. 4. After a period of approximately three days, the butane injections were halted. During the hours not shown in the table, the bioreactor was operated with aeration and mixing without butane injection.

TABLE 1
Sludge Odor Treatment

| | | | Aeration | |
|---|---|---|---|---|
| Day No. | Time | Volume of Butane | (200 L/hr) | Mixing |
| 1 | 19:00 | 500 ml | On | On |
| 1 | 20:00 | 500 ml | On | On |
| 1 | 21:00 | 500 ml | On | On |
| 2 | 08:00 | 500 ml | On | On |
| 2 | 09:00 | 500 ml | On | On |
| 2 | 11:00 | 500 ml | On | On |
| 2 | 12:00 | 500 ml | On | On |
| 2 | 13:00 | 500 ml | On | On |
| 2 | 14:00 | 500 ml | On | On |
| 2 | 15:00 | 500 ml | On | On |
| 2 | 16:00 | 500 ml | On | On |
| 2 | 17:00 | 500 ml | On | On |
| 2 | 18:00 | 500 ml | On | On |
| 2 | 19:00 | 500 ml | On | On |
| 2 | 20:00 | 500 ml | On | On |
| 3 | 10:00 | 500 ml | On | On |
| 3 | 11:00 | 500 ml | On | On |
| 3 | 12:00 | 500 ml | On | On |
| 3 | 13:00 | 500 ml | On | On |
| 3 | 14:00 | 500 ml | On | On |
| 3 | 15:00 | 500 ml | On | On |
| 3 | 16:00 | 500 ml | On | On |
| 3 | 17:00 | 500 ml | On | On |
| 3 | 18:00 | 500 ml | On | On |

All odors associated with the RAS sludge sample were not detectable by olfactory senses after the first three butane injections conducted on Day No. 1. Thus, the introduction of butane controlled odor generated by the wastewater. In addition, the RAS slurry immediately thinned (within 10 hours) after the butane injections. The RAS appeared less dense with a flocculant consistency.

### EXAMPLE 2

A butane-injection system was installed in a municipal wastewater treatment plant comprising an extended aeration activated sludge system. The plant included an aerated 12,000 gallon sludge thickening and holding tank. The sludge tank, which typically emits a noticeable odor, was equipped with an air/butane injector and diffuser. The injector constantly fed air to the tank at a rate of about 5 cubic feet per minute. Twice per day butane was added to the injected air stream for 6 minutes. During an initial 8-day period, a total amount of approximately 120 pounds of butane was pulsed to the tank. Odor associated with the sludge tank was noticeably reduced following butane injection.

After the initial 8-day period, settleable solids of the sludge were measured by placing a sample of the treated sludge in a one liter container and observing the upper level of the settleable solids versus the upper level of the liquid after 120 minutes. The initial 8-day sample had a 50 ml/l drop after 120 minutes. A subsequent 8-day test was then conducted. All but 2,000 gallons of the initial butane treated sludge was removed from the tank, and the tank was refilled with fresh sludge. Air and butane were injected into the sludge tank in the same manner as the initial 8-day test. Once again, the odor associated with the sludge tank was reduced. After the second 8-day treatment period, settleable solids were measured as a 75 ml/l drop after 120 minutes. The greater drop after the second 8-day test indicates improved settleable solids reduction. Optimization of the butane injection process would further optimize the solids reduction. In addition to solids reduction resulting from the butane treatment, upon initiation of the butane injection, odor of the sludge tank was substantially reduced.

In accordance with an embodiment of the present invention, butane enhanced treatment of wastewater may be conducted as a modification of existing aeration tanks in municipal or chemical wastewater treatment facilities or as stand alone or ancillary treatment reactors. Many variations or process permutations exist or may be implemented using the alkane process. The process could be modified to pre-treat sludge, treat sludge on-line, treat return sludge, lower biological oxygen demand, total organic carbon or any other form of wastewater where solids reduction, odor control or organics removal is desirable. The alkane process may also be used to further treat sludge obtained from anaerobic digestion processes. The process may be used to reduce solids and odor in any type of wastewater effluent. Furthermore, butane may be injected into wastewater early in the treatment process to abate nuisance odors associated with wastewater liquids/solids.

### EXAMPLE 3

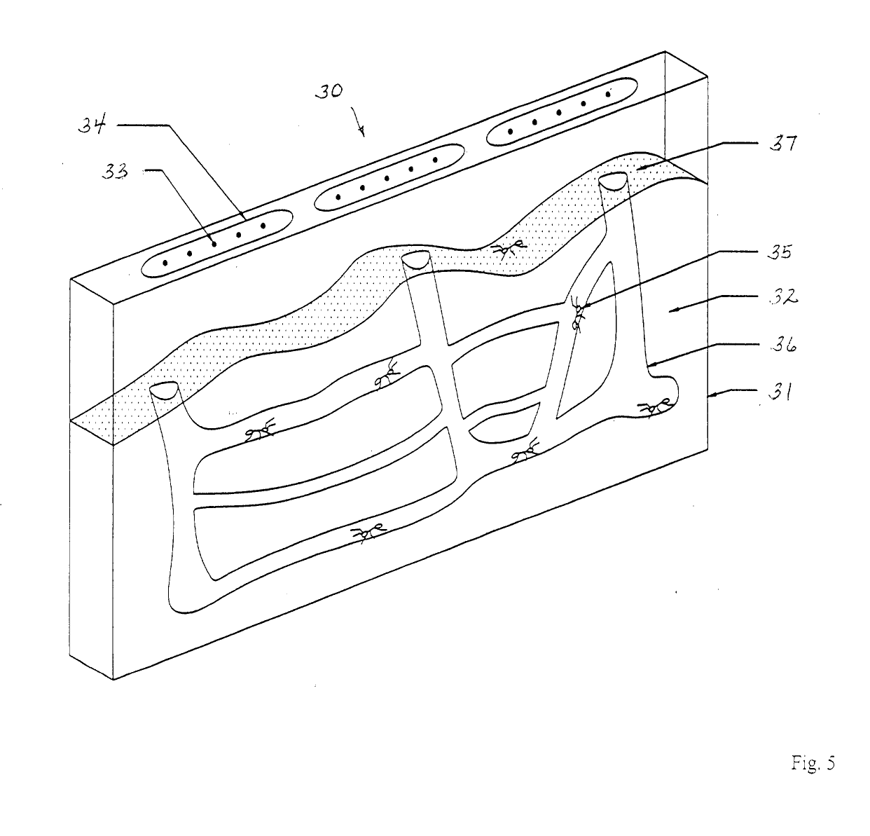

A study using ant habitats was conducted to measure the effects of butane introduction and odor control. FIG. 5 depicts a control habitat 30 comprising a clear plastic ant farm 31 partially filled with sand 32. The plastic ant farm 31 contains air supply holes 33 and feeding ports 34 to provide air and food to ants 35 located within the ant farm 31. The ants 35 form tunnels 36 within the sand 32, thereby creating an ant hill 37.

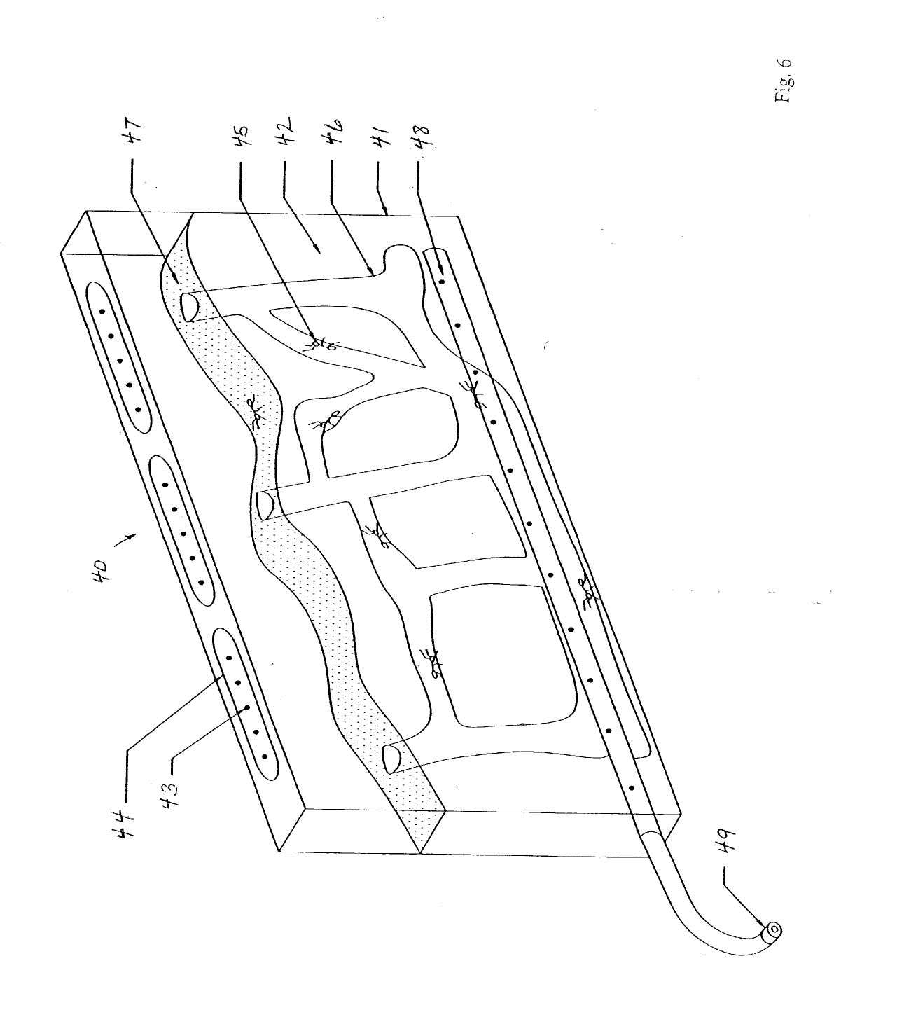

FIG. 6 illustrates a butane enhanced habitat 40 comprising a clear plastic ant farm 41 partially filled with sand 42. The plastic ant farm 41 contains air supply holes 43 and feeding ports 44 to provide air and food to ants 45 located within the ant farm 41. The ants 45 form tunnels 46 within the sand 42, thereby creating an ant hill 47. A butane/air injection tube 48 runs through the ant hill 47 to introduce air and/or butane gas. A butane/air injection port 49 is located at one end of the butane/air injection tube 48.

Two ant habitats similar to those shown in FIGS. 5 and 6 having dimensions of 24 cm×37 cm×0.75 cm were equipped with clear plastic walls, side micro-air vents and top feeding vents with removable covers were filled with sand to a height of 12 cm, leaving a 12 cm air headspace. The two habitats were labeled control habitat (CH) (FIG. 5) and butane enhanced habitat (BEH) (FIG. 6). BEH was prepared with a tygon injection tube (50 cm length) connected at one end to the habitat side/bottom and extending 35 cm inside the bottom of the habitat. The section of tubing inside the habitat was perforated with 11 butane/air injection holes positioned at 3 cm intervals. The 15 cm section of tubing extending outside the habitat was connected at the end to a butane/air injection syringe port equipped with a Teflon coated septum. Fifteen ants were introduced into each habitat.

The study was performed over a 95 day period. During this period, ambient temperature ranged from 65° lights off to 72° lights on. The ants were fed a diet of sugar water, placed by drops with a dropper, and occasionally particles of ant food (a blend of protein, grain and seeds) placed through top feeding vents. The ants in the two habitats were fed, and BEH received injections of 50/50 air/n-butane mixture via gas tight syringe through the syringe port, according to the regimen in Table 2.

TABLE 2
Ant Habitat Odor Treatment

| Day | | | Sugar Water | Food | N-Butane / Air Mix |
|---|---|---|---|---|---|
| No. | Time | Habitat | (drops) | (particles) | (ml) |
| 1 | 15:00 | CH | 6 | 10 | — |
| | | BEH | 6 | 10 | — |
| 4 | 12:00 | CH | 12 | | — |
| | | BEH | 12 | | — |
| 5 | 14:40 | CH | 12 | | — |
| | | BEH | 12 | 25/25 | |
| 6 | 11:18 | CH | 6 | 5 | — |
| | | BEH | 6 | 5 | 25/25 |
| 7 | 11:15 | CH | 12 | | — |
| | | BEH | 12 | | 25/25 |
| 8 | 13:25 | CH | 20 | | — |
| | | BEH | 20 | | 25/25 |
| 9 | 15:23 | CH | 20 | | — |
| | | BEH | 20 | | 25/25 |
| 10 | 14:10 | CH | — | | — |
| | | BEH | — | | 25/25 |
| 11 | 10:25 | CH | 20 | | — |
| | | BEH | 20 | | 25/25 |
| 12 | 09:00 | CH | — | | |
| | | BEH | — | | 55/45 |
| 13 | 09:13 | CH | — | | |
| | | BEH | | | 50/50 |
| 14 | 09:21 | CH | — | — | — |
| | | BEH | — | — | 50/50 |
| 15 | 09:00 | CH | 20 | — | — |
| | | BEH | 20 | — | 50/50 |
| 16 | 14:38 | CH | — | — | — |
| | | BEH | — | — | 50/50 |
| 17 | 12:10 | CH | 10 | — | — |
| | | BEH | 10 | — | 50/50 |
| 18 | 10:00 | CH | — | — | — |
| | | BEH | — | — | 50/50 |
| 19 | 10:16 | CH | 10 | — | — |
| | | BEH | 10 | — | 50/50 |
| 20 | 09:36 | CH | — | — | — |
| | | BEH | — | — | 50/50 |
| 21 | 08:32 | CH | 10 | — | — |
| | | BEH | 10 | — | 50/50 |
| 22 | 09:36 | CH | — | — | — |
| | | BEH | — | — | 50/50 |
| 23 | 11:50 | CH | 10 | — | — |
| | | BEH | 10 | — | 50/50 |
| 24 | 17:15 | CH | 10 | — | — |
| | | BEH | 10 | — | 50/50 |
| 25 | 12:10 | CH | 10 | — | — |
| | | BEH | 10 | — | 50/50 |
| 26 | 10.05 | CH | — | 10 | — |
| | | BEH | — | 10 | 50/50 |
| 27 | 09:53 | CH | 10 | — | — |
| | | BEH | 10 | — | 50/50 |
| 28 | 11:10 | CH | 10 | — | — |
| | | BEH | 10 | — | 50/50 |
| 29 | 21:37 | CH | 10 | — | — |
| | | BEH | 10 | — | 50/50 |
| 31 | 09:00 | CH | — | — | — |
| | | BEH | — | — | 100 ml pure n-butane |
| 32 | 09:51 | CH | 10 | — | — |
| | | BEH | 10 | — | 50/50 |
| 33 | 09:30 | CH | — | — | — |
| | | BEH | — | — | 50/50 |
| 34 | 09:00 | CH | 10 | — | — |
| | | BEH | 10 | — | 50/50 |
| 35 | 20:16 | CH | — | — | — |
| | | BEH | — | — | 50/50 |
| 36 | 10:15 | CH | 10 | — | — |
| | | BEH | 10 | — | 50/50 |
| 38 | 09:00 | CH | 15 | — | — |
| | | BEH | 15 | — | 75/75 |
| 39 | 10:12 | CH | — | — | — |
| | | BEH | — | — | 75/75 |
| 41 | 10:42 | CH | 10 | — | — |
| | | BEH | 10 | — | 75/75 |
| 42 | 11:45 | CH | — | — | — |
| | | BEH | — | — | 75/75 |
| 43 | 16:51 | CH | 15 | — | — |
| | | BEH | — | — | 75/75 |
| 46 | 11:45 | CH | 15 | — | — |
| | | BEH | — | — | 75/75 |
| 48 | 09:58 | CH | 10 | — | — |
| | | BEH | 10 | — | 75/75 |
| 49 | 14:58 | CH | — | — | — |
| | | BEH | — | — | 75/75 |
| 50 | 10:37 | CH | 15 | — | — |
| | | BEH | 15 | — | 75/75 |
| 53 | 09:14 | CH | 15 | — | — |
| | | BEH | 15 | — | 75/75 |
| 54 | 09:38 | CH | — | — | — |
| | | BEH | — | — | 75/75 |
| 55 | 17:30 | CH | 15 | — | — |
| | | BEH | 15 | — | 75/75 |
| 56 | 16:15 | CH | — | — | — |
| | | BEH | — | — | 75/75 |
| 60 | 10:00 | CH | 15 | — | — |
| | | BEH | 15 | — | 75/75 |
| 62 | 09:03 | CH | 15 | — | — |
| | | BEH | 15 | — | 75/75 |
| 63 | 12:00 | CH | — | — | — |
| | | BEH | — | — | 75/75 |
| 64 | 12:32 | CH | 15 | — | — |
| | | BEH | 15 | — | 75/75 |
| 67 | 09:44 | CH | 15 | — | — |
| | | BEH | 15 | — | 75/75 |
| 68 | 09:33 | CH | 10 | — | — |
| | | BEH | 10 | — | 75/75 |
| 69 | 11:42 | CH | — | — | — |
| | | BEH | — | — | 75/75 |
| 70 | 11:30 | CH | 10 | — | — |
| | | BEH | 10 | — | 75/75 |
| 76 | 11:41 | CH | 10 | — | — |
| | | BEH | 10 | — | 100/100 |
| 77 | 09:00 | CH | 10 | — | — |
| | | BEH | 10 | — | 100/100 |
| 81 | 09:15 | CH | 10 | — | — |
| | | BEH | 10 | — | 100/100 |
| 84 | 09:24 | CH | 10 | — | — |
| | | BEH | 10 | — | 100/100 |
| 85 | 09:30 | CH | 10 | — | — |
| | | BEH | 10 | — | 100/100 |
| 88 | 09:15 | CH | 10 | — | — |
| | | BEH | 10 | — | 100/100 |
| 90 | 09:21 | CH | 10 | — | — |
| | | BEH | 10 | — | 100/100 |
| 91 | 09:17 | CH | 10 | — | — |
| | | BEH | 10 | — | 100/100 |
| 92 | 9:47 | CH | 10 | — | — |
| | | BEH | 10 | — | 100/100 |
| 93 | 19:24 | CH | 12 | — | — |
| | | BEH | 12 | — | 100/100 |
| 95 | 15:00 | CH | 12 | — | — |
| | | BEH | 12 | — | 100/100 |

Ants in BEH display increased activity/frantic behavior during and immediately following butane injections. On Day No. 12, 2 seeds (from food) were observed to have germinated in BEH. On Day No. 26, 10 particles of food were added to each habitat. Ants in BEH noticed and approached food immediately. Ants in CH did not appear to notice or approach food until at least 5 minutes after BEH ants. Ants in both habitats build hills up into the air headspace, reducing headspace to approximately 6-8 cm. Ants in CH built predominantly horizontal tunnels, extending the length of the habitat, while ants in BEH built predominantly vertical tunnels extending down to the butane injection tube. On Day No. 55, the two habitats were tested for odor. Upon opening of top vents, CH emitted a strong ammonia odor. BEH emitted no unpleasant odor, rather, an odor of fresh earth. From Day 55 through the end of the experiment, the odor of ammonia and decaying organic matter (uneaten food and dead ants) in CH increased in strength, while BEH remained free of unpleasant odors. The foregoing example demonstrates that butane effectively controls odor in ant habitats.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of remediating an odorous medium, the method comprising introducing an alkane substrate to the odorous medium.

2. The method of claim 1, wherein the alkane substrate comprises butane.

3. The method of claim 1, wherein the alkane substrate comprises butane as the most prevalent compound on a weight percentage basis.

4. The method of claim 1, wherein the alkane substrate comprises at least about 10 weight percent butane.

5. The method of claim 1, wherein the alkane substrate comprises propane.

6. The method of claim 1, wherein the alkane substrate stimulates the growth of alkane-utilizing bacteria.

7. The method of claim 6, wherein the alkane-utilizing bacteria comprise aerobic bacteria.

8. The method of claim 6, wherein the alkane-utilizing bacteria comprise anaerobic bacteria.

9. The method of claim 1, further comprising introducing oxygen-containing gas to the odorous medium.

10. The method of claim 9, wherein the oxygen-containing gas is introduced in the form of air.

11. The method of claim 1, wherein the odorous medium comprises a liquid.

12. The method of claim 1, wherein the odorous medium comprises water.

13. The method of claim 1, wherein the odorous medium comprises wastewater.

14. The method of claim 1, wherein the odorous medium comprises a solid material.

15. The method of claim 1, wherein the odorous medium comprises a slurry.

16. The method of claim 1, wherein the odorous medium comprises sludge.

17. The method of claim 1, wherein the odorous medium comprises a gas.

18. The method of claim 1, wherein the odorous medium comprises fish waste.

19. The method of claim 1, wherein the odorous medium comprises algae or algal material.

20. The method of claim 1, wherein the odorous medium is provided from at least one source selected from solid waste, landfills, wastewater, septic systems, sanitary sewer systems, water distribution systems, poultry processing, fish processing, fish waste, meat processing, slaughterhouses, farms, and food processing.

21. The method of claim 1, further comprising introducing a petroleum hydrocarbon substrate to the odorous medium.

22. An apparatus for introducing an alkane substrate to an odorous medium, the apparatus comprising:
a source of alkane substrate; and
an injection system in communication with the source of alkane substrate and the odorous medium.

23. The apparatus of claim 22, wherein the alkane substrate comprises butane.

24. The apparatus of claim 22, wherein the alkane substrate comprises butane as the most prevalent compound on a weight percentage basis.

25. The apparatus of claim 22, wherein the alkane substrate comprises at least about 10 weight percent butane.

26. The apparatus of claim 22, wherein the alkane substrate comprises propane.

27. The apparatus of claim 22, further comprising means for introducing an oxygen-containing gas to the odorous medium.

28. The apparatus of claim 22, wherein the odorous medium comprises at least one material selected from liquid, water, wastewater, solid materials, slurries, sludges, gases, fish waste, algae and algal material.

29. The apparatus of claim 22, wherein the odorous medium is provided from at least one source selected from solid waste, landfills, wastewater, septic systems, sanitary sewer systems, water distribution systems, poultry processing, fish processing, fish waste, meat processing, slaughterhouses, farms, and food processing.
